(19) United States
(12) Patent Application Publication
(10) Pub. No.: US 2002/0030764 A1
(43) Pub. Date: Mar. 14, 2002

(54) Digital TV for use in a home wide web and method of changing a channel in the same

(76) Inventors: Min-Young Kim, Seoul-city (KR); Hyun-Chol Choi, Yeosu-city (KR)

Correspondence Address: Robert E. Bushnell, Suite 300, 1522 K Street, N.W., Washington, DC, 20005-1202, US

(21) Appl. No.: 09/945,108

(22) Filed: Sep. 4, 2001

(30) Foreign Application Priority Data
Sep. 6, 2000 (KR) 52778/2000
Sep. 6, 2000 (KR) 52779/2000

(51) Int. Cl. H04N 5/44; H04N 5/50

(52) U.S. Cl. 348/731; 348/553

(57) ABSTRACT

A digital TV for use in a home wide web includes: a tuner for receiving a broadcast of a current channel; a controller for outputting a control signal to change the current channel to a user input channel; a channel information processor for extracting user input channel information from the control signal from the controller, and for transferring the extracted user input channel information to the tuner; and a memory including a program for operation of the controller, for storing a current channel information, and for changing the current channel information to the user input channel information. The changed channel information is stored in the form of a file or as one or more cookies in accordance with the method of changing the channel in the digital TV. As a result, a broadcast of the user input channel is displayed without displaying the channel selection page.

### CLAIM OF PRIORITY

This application makes reference to, incorporates the same herein, and claims all benefits accruing under 35 U.S.C. §119 from my two applications both entitled METHOD FOR SELECTING CHANNEL OF DIGITAL TV and both filed with the Korean Industrial Property Office on Sep. 6, 2000 and there duly assigned Serial Nos. 52778/2000 and 52779/2000.

### BACKGROUND OF THE INVENTION

1. Technical Field

The present invention relates to a digital TV for use in a home wide web and a method of changing a channel in the same.

2. Related Art

The term “home wide web” indicates a technology in which all home appliances are connected via a serial interface called “IEEE 1394” and are remote-controlled through a digital TV. For example, in a conventional home wide web, a set-top box, a digital VCR, a DVD player, a computer, etc. are connected by a network, centering on a digital TV. The digital TV may have a separate domain (i.e., an Internet address), and thus a user can control home appliances wherever the Internet is present.

Using an IEEE 1394 protocol, the digital TV for use in such a home wide web has a feature whereby a channel change screen (or channel selection page) configured in the form of a web page is displayed whenever a user changes a channel.

The channel change screen includes a channel field which displays a current channel number, an up/down icon display field by means of which a user turns a channel up or down using a remote controller, a confirm button for confirming a channel selection, and a cancel button for canceling a channel selection.

If a user wants to change a channel, the user selects a desired channel before pushing on the confirm button. Selected channel information or channel value is transferred to a tuner of the digital TV, so that a screen corresponding to the selected channel is displayed on the digital TV.

The digital TV includes a tuner, a channel portion, an A/V signal processor, an A/V signal output, a memory, a protocol processor, a controller, an external signal input, a keypad, and a remote controller. The digital TV is controlled by a control signal received from the remote controller.

The tuner receives a digital multi-channel television-broadcasting signal, and generates and outputs a base band signal of a corresponding channel in response to a control signal of the controller transmitted through the protocol processor. Then, the channel portion channel-decodes the base band signal of the corresponding channel to reproduce a data bit string, and thereafter separates the data bit string into audio data and video data. The audio and video data are transferred to the A/V signal processor. The A/V signal processor processes corresponding data, and outputs the processed data via the A/V signal output to an external portion.

The controller performs an operation corresponding to a command inputted via the keypad or the remote controller by a program (e.g., CGI program) stored in the memory. That is, the command inputted through the keypad or the remote controller is applied to the controller through an external signal input, and the controller converts the command through the protocol processor to comply with IEEE 1395 protocol, and then transmits the converted command via a bus to the tuner, the channel portion, the A/V signal processor, and the A/V signal output.

The memory includes a nonvolatile memory, such as a ROM and a flash memory, a volatile memory such as a RAM, and an EEPROM. The nonvolatile memory stores a program of the controller for controlling operation of the digital TV. The volatile memory temporarily stores data generated during performance of the program of the controller. The EEPROM stores various kinds of data.

In the conventional digital TV for use in the home wide web, an operation is programmed in the nonvolatile memory, such as a ROM of the memory, and the operation is to be performed by the controller. First, when a user turns on the digital TV, it is determined whether there is a request for a channel change from the user. If the user requests change of channel, the channel change screen is produced, and then the channel change screen is displayed on the digital TV. The user manipulates the remote controller to select an up icon (▴) or a down icon (▾) of the up/down icon display field to change a channel number of the channel field, so that the channel change screen is changed to one having the channel desired by the user. For example, when a current channel is set to “77”, if a user manipulates the remote controller to select the up icon (▴) of the up/down icon display field, the channel number on the channel field is changed to “78”. In order to change a channel to a desired channel, the user may continue to select the up icon or the down icon of the up/down icon display field. When a channel is selected by the method described above, the user selects the confirm button to complete the channel change. As a result, the broadcast of the selected channel is displayed on the digital TV.

However, such a method of changing a channel in the conventional digital TV for use in the home wide web has a disadvantage in that the channel change screen should be displayed whenever the user changes the channel to a desired channel because the digital TV for use in the home wide web uses the IEEE 1394 protocol. Therefore, compared with a current TV in which the channel is automatically changed by manipulating a channel selection key without displaying the channel change screen, the method of changing a channel in the conventional digital TV for use in the home wide web is very inconvenient.

For the foregoing reason, there is a need for a digital TV for use in a home wide web in which a channel is automatically changed by manipulating a keypad or a remote controller without displaying the channel change screen.

### SUMMARY OF THE INVENTION

To overcome the problems described above, preferred embodiments of the present invention provide a digital TV for use in a home wide web which do not display a channel change screen when the user changes the channel.

It is another object of the present invention to provide a method of changing a channel in a digital TV for use in a home wide web without displaying a channel change screen.

In order to achieve the above objects, the preferred embodiments of the present invention provide a digital TV for use in a home wide web. A tuner receives the broadcast of a current channel. A controller outputs a control signal to change the current channel to a user input channel. A channel information processor extracts user input channel information from the control signal from the controller, and transfers the extracted user input channel information to the tuner. A memory includes a program for control by the controller, stores current channel information, and changes the current channel information in accordance with the user input channel information, whereby a broadcast of the user input channel is displayed without displaying the channel selection page.

The program stores the current channel information in the form of a file or as a cookie file.

The preferred embodiment of the present invention provides a method of changing a channel in a digital TV for use in a home wide web. The method comprises the steps of: producing a channel selection page to change a current channel when a user requests a change of the current channel; producing and storing a first cookie for the channel selection page; changing an information of the channel selection page to change the current channel to a user input channel; producing and storing a second cookie for the changed channel selection page; and changing the current channel to the user input channel by means of channel information contained in the second cookie, whereby a broadcast of the user input channel is displayed without displaying the channel selection page.

The channel information contained in the second cookie is determined by searching a string contained in the second cookie.

The preferred embodiment of the present invention further provides a method of changing a channel in a digital TV for use in a home wide web. The method comprises the steps of: producing a channel selection page to change a current channel when a user requests a change of the current channel; extracting channel information from the channel selection page, and storing the extracted channel information in the form of a file; changing the channel information stored in the form of a file in response to an operation by the user; and changing the current channel to the user input channel by means of the changed channel information, whereby a broadcast of the user input channel is displayed without displaying the channel selection page.

When the user manipulates a direction key to select the user input channel, a value of the current channel is increased or decreased by as much as “1”. When the user manipulates a digit key to select the user input channel, the step of changing the channel information stored in the form of a file includes: producing a channel selection page corresponding to an input digit; extracting the channel information from the produced channel selection page, and calculating a difference between a value of the extracted channel information and a value of the channel information stored in the form of a file; and changing the channel information stored in the form of a file as much as the difference value.

The digital TV for use in the home wide web and the method of changing a channel in the same have an advantage in that it is very convenient o change a channel because a channel can be changed without displaying a channel change screen. In addition, since information for various home appliances controlled by the digital TV can be stored in the cookie file when a channel selection page is produced, various services associated with the home wide web may be provided.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference numerals indicate the same or similar components, and wherein:

FIG. 1 illustrates a configuration of a home wide web;

FIG. 2 illustrates a channel change screen of a digital TV for use in the home wide web;

FIG. 3 is a block diagram illustrating a configuration of the conventional digital TV for use in the home wide web;

FIG. 4 is a flow chart illustrating a method of changing a channel in the conventional digital TV for use in the home wide web;

FIG. 5 is a block diagram illustrating a configuration of a digital TV for use in a home wide web according to a preferred embodiment of the present invention;

FIG. 6 is a flow chart illustrating a method of changing a channel in the digital TV for use in the home wide web according to a preferred embodiment of the present invention; and

FIG. 7 is a flow chart illustrating another method of changing a channel in the digital TV for use in the home wide web according to a preferred embodiment of the present invention.

### DETAILED DESCRIPTION OF PREFERRED EMBODIMENTS

Reference will now be made in detail to preferred embodiments of the present invention, example of which is illustrated in the accompanying drawings.

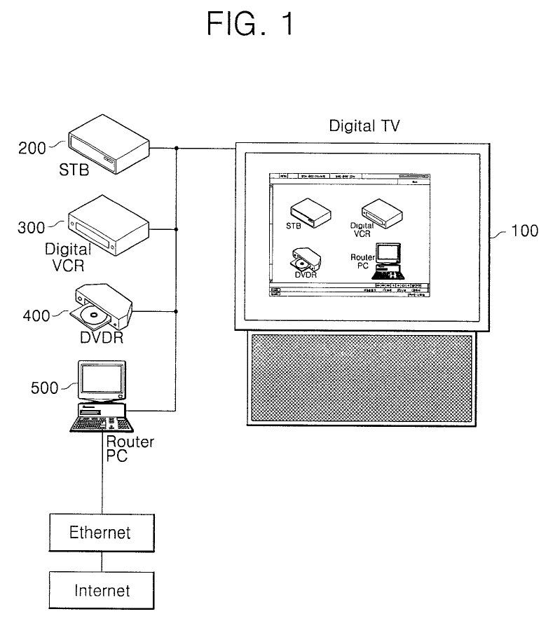

FIG. 1 illustrates a configuration of a home wide web. Referring to FIG. 1, a set-top box 200, a digital VCR 300, a DVD player 400, a computer 500, etc., are connected by a network, centering on a digital TV 100. The digital TV 100 may have a separate domain (i.e., an Internet address), and thus a user can control home appliances wherever there is an Internet service.

Using an IEEE 1394 protocol, the digital TV for use in such a home wide web has a feature whereby a channel change screen (or channel selection page) configured in the form of a web page has to be displayed whenever a user changes a channel.

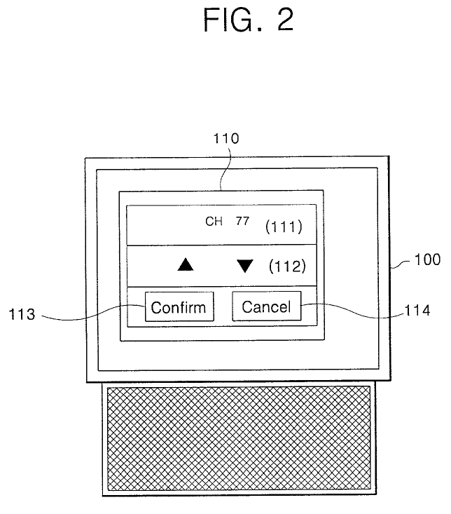

FIG. 2 illustrates a channel change screen of a digital TV for use in the home wide web. Referring to FIG. 2, the channel change screen 110 includes a channel field 111 which displays a current channel number, an up/down icon display field 112 by which a user turns a channel up or down using a remote controller, a confirm button 113 for confirming a channel selection, and a cancel button 114 for canceling a channel selection.

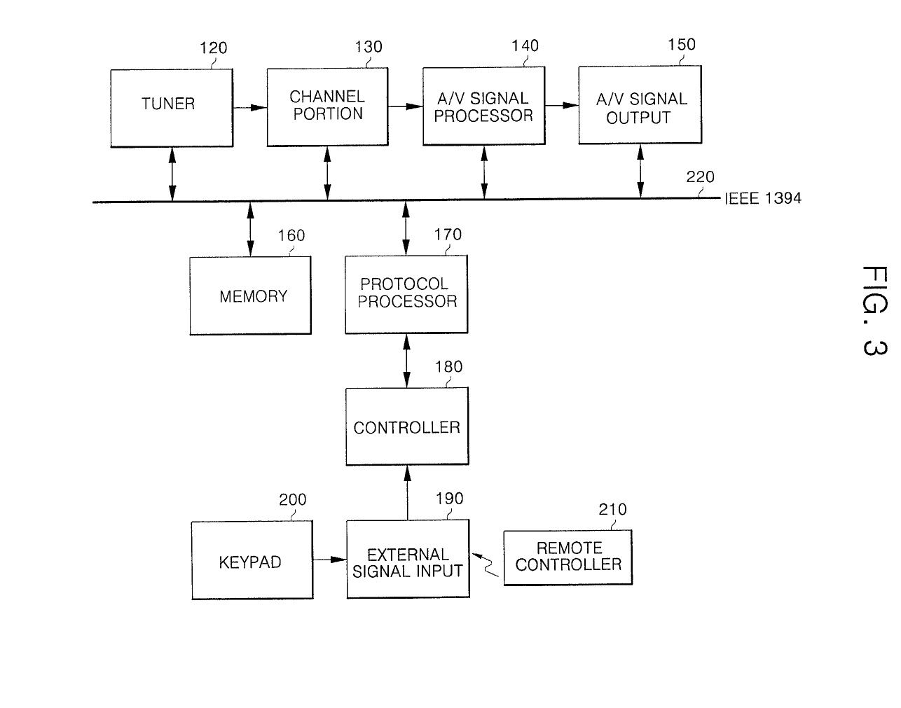

If the user wants to change a channel, the user selects a desired channel before pushing the confirm button 113. Selected channel information or channel value is transferred to a controller 180 (FIG. 3) of the digital TV so that a screen corresponding to the selected channel is displayed on the digital TV.

FIG. 3 is a block diagram illustrating the configuration of a digital TV for use in the home wide web. As shown in FIG. 3, the digital TV includes a tuner 120, a channel portion 130, an A/V signal processor 140, an A/V signal output 150, a memory 160, a protocol processor 170, a controller 180, an external signal input 190, a keypad 200, and a remote controller 210. The digital TV is controlled by a control signal received from the remote controller 210.

The tuner 120 receives a digital multi-channel television-broadcasting signal, and generates and outputs a base band signal of a corresponding channel in response to the control signal of the controller 180 as transmitted through the protocol processor 170. Then, the channel portion 130 channel-decodes the base band signal of the corresponding channel to reproduce a data bit string, and thereafter separates the data bit string into audio data and video data. The audio and video data are transferred to the A/V signal processor 140b. The A/V signal processor 140 processes corresponding data and outputs that data via the A/V signal output 150 to an external portion.

The controller 180 performs an operation corresponding to a command inputted via the keypad 200 or the remote controller 210 by means of a program (e.g., CGI program) stored in the memory 160. That is, the command inputted through the keypad 200 or the remote controller 210 is applied to the controller 180 through external signal input 190. The controller 180 converts the command through the protocol processor 170 to comply with the IEEE 1395 protocol, and transmits the converted command via bus 220 to the tuner 120, the channel portion 130, the A/V signal processor 140, and the A/V signal output 150.

The memory 160 includes a nonvolatile memory, such as a ROM and a flash memory, a volatile memory such as a RAM, and an EEPROM. The nonvolatile memory stores a program of the controller 180 for controlling operation of the digital TV. The volatile memory temporarily stores data generated during performance of the program by the controller 180. The EEPROM stores various kinds of data.

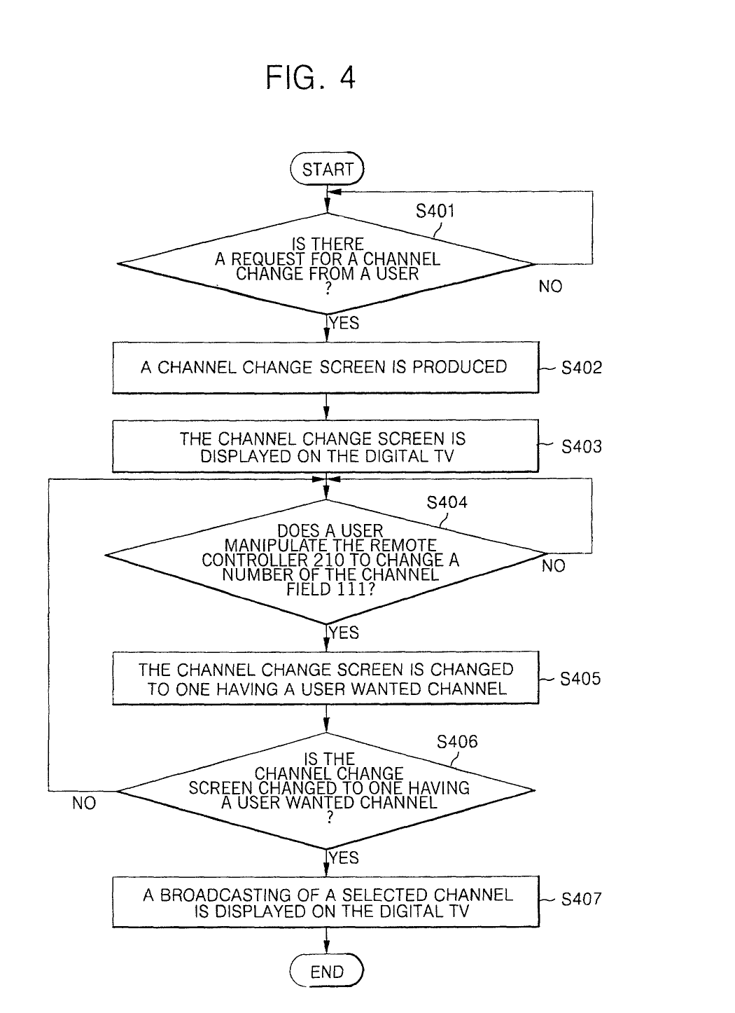

FIG. 4 is a flow chart illustrating a method of changing a channel in a digital TV for use in the home wide web. The operation of FIG. 4 is programmed in the nonvolatile memory, such as a ROM, of the memory 160 so as to be performed by the controller 180. First, when the user turns on the digital TV, it is determined whether there is a request for a channel change from the user (step 401). If the user requests a change of channel, the channel change screen of FIG. 2 is produced (step 402), and then the channel change screen of FIG. 2 is displayed on the digital TV (step 403). If the user manipulates the remote controller 210 to select an up icon (▴) or a down icon (▾) of the up/down icon display field 112 to change the channel number of the channel field 111 (step 404), the channel change screen is changed to one having a channel desired by the user (step 405). For example, as shown in FIG. 2, a current channel is set to “77”. If the user manipulates the remote controller 210 to select the up icon (▴) of the up/down icon display field 112, a channel number on the channel field 111 is changed to “78”. In order to change the channel to a desired channel, the user may continue to select the up icon or the down icon of the up/down icon display field 112. When a channel is selected by the method described above, the user selects the confirm button 113 to complete the channel change (step 406). As a result, a broadcast of a selected channel is displayed on the digital TV (step 407).

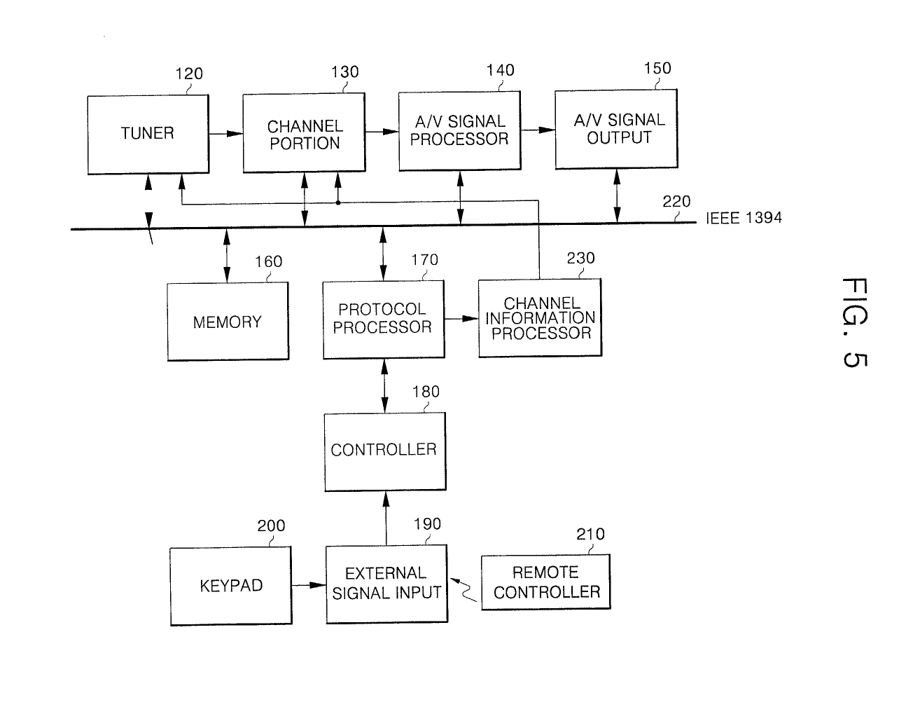

FIG. 5 shows an internal block diagram of digital TV for use in the home wide web according to the preferred embodiment of the present invention. As shown in FIG. 5, the inventive digital TV includes a tuner 120, a channel portion 130, an A/V signal processor 140, an A/V signal output 150, a memory 160, a protocol processor 170, a controller 180, an external signal input 190, a keypad 200, a bus 220, and a channel information processor 230.

Components common to FIGS. 3 and 5 perform identical operations, and thus their explanation is omitted.

The channel information processor 230 extracts a channel information (i.e., channel value) contained in a channel selection command from a control command generated from the controller 180, and the channel information is processed by processor 170 to satisfy the IEEE 1394 protocol. The extracted channel information is transferred from the channel information processor 230 to the tuner 120 and the channel portion 130, which are components that perform operations related to channel change or selection in the digital TV.

In more detail, when a user manipulates either the keypad 200 or the remote controller 210 to change a channel, the channel information processor 230 extracts a channel value desired by the user, and directly transfers only the channel value desired by the user to the tuner 120 and the channel portion 130. At this moment, the channel information processor 230 operates independent of the IEEE 1394 protocol, whereupon a channel selection page generated by the IEEE 1394 protocol is not displayed.

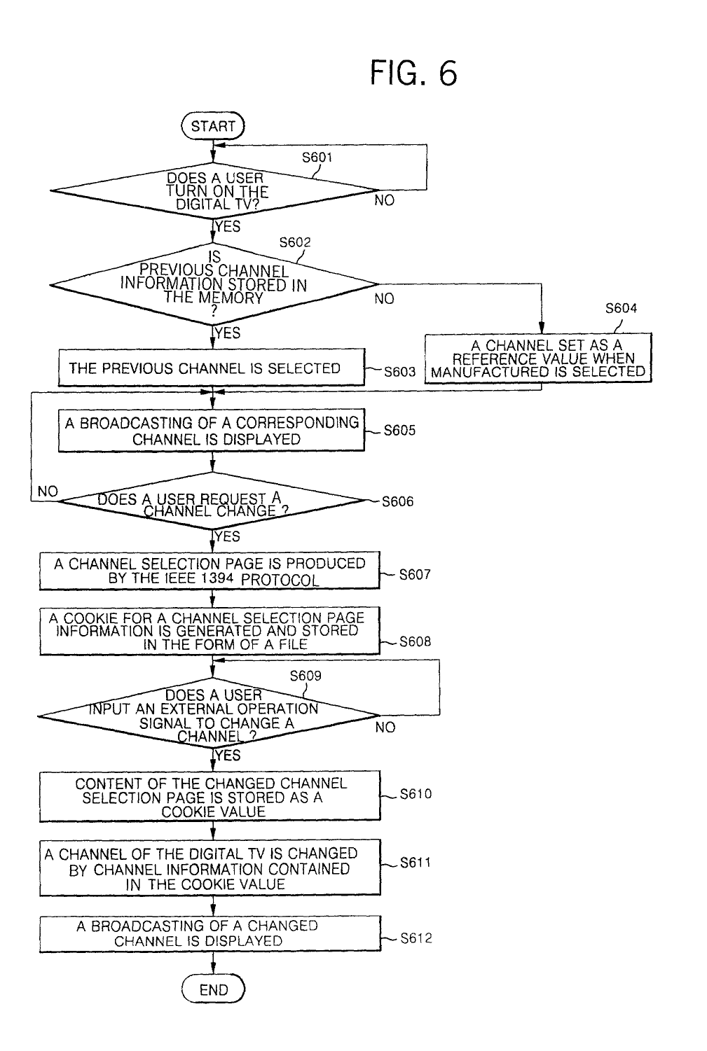

FIG. 6 is a flow chart illustrating a method of changing a channel in the digital TV for use in the home wide web according to the preferred embodiment of the present invention. The operation of FIG. 6 is programmed in a nonvolatile memory, such as a ROM, of the memory 160 for performance by the controller 180. First, when a user turns on the digital TV (step 601), it is determined whether previous channel information is stored in the memory 160 (step 602). If the previous channel information is stored in the memory 160, the previous channel is selected (step 603). If the previous channel information is not stored in the memory 160, a channel set as a reference value when manufactured is selected (step 604). A broadcast of the channel selected in one of steps 603 and 604 is displayed until there is a request from the user for a channel change (step 605). When a user makes a request for a channel change (step 606), a channel selection page is produced by the IEEE 1394 protocol (step 607), and a cookie for channel selection page information is generated and stored in the form of a file (step 608). At this point, the channel selection page produced above is internally produced, and thus not displayed.

The “cookie” is a text file that is inserted in a hard disk of the user by a web site. The cookie generally records a user taste for the web site. Using a hypertext transfer protocol (HTTP), respective demands for web pages are independent of each other. Therefore, a web server does not keep or generate any record as to which page is sent to the user, and does not even know whether or not the user visited the web site. Therefore, the cookie is a mechanism to allow the web server to store files for the user in the user computer. A cookie directory stores all cookie files for respective web sites where a user visited once. In order to make such a cookie, the following syntax is made using a CGI script: “Set-cookie: NAME-VALUE; expires=DATE;”. At this time, as inscribed in the syntax, both a file name and the term of a valid cookie can be set.

After the cookie is generated, when a user inputs an external operation signal to change a channel (step 609), the channel selection page information produced in step 607 is changed in response to the external control signal, and then the content of the changed channel selection page is stored as a cookie value (step 610). That is, whenever channel selection page information is changed by a user, the content of the changed channel selection page is stored as a cookie value.

A channel of the digital TV is changed by channel information contained in the cookie value (step 611), and thereafter a broadcast of the changed channel is displayed (step 612). At this point, in order to extract channel information from the cookie value, a string contained in the cookie value is searched.

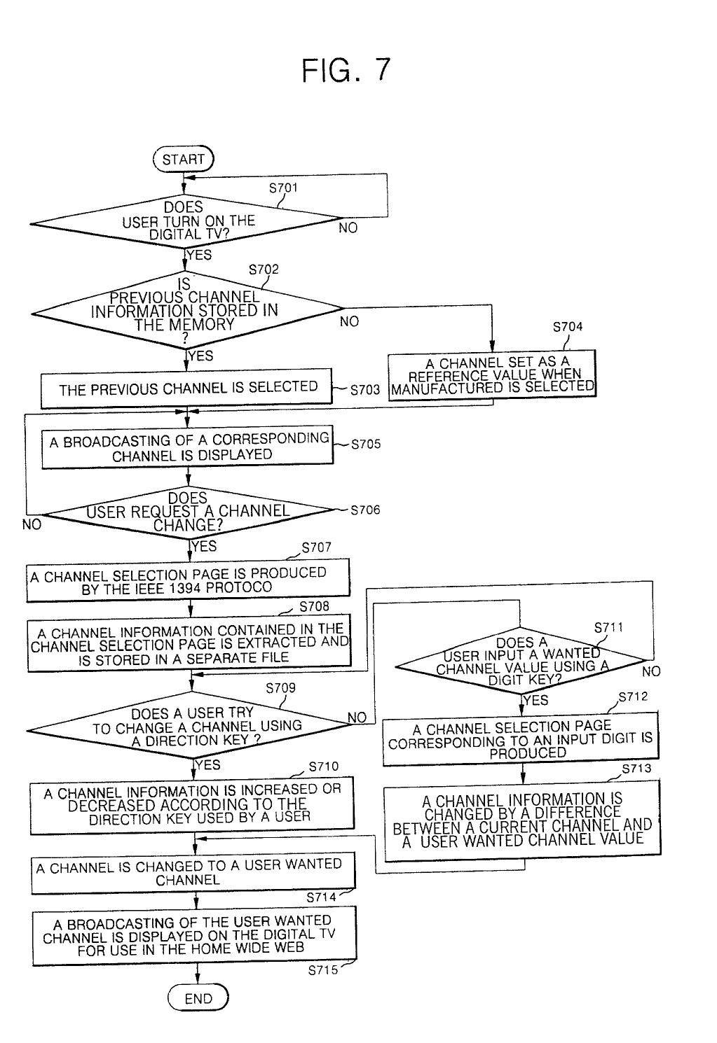

FIG. 7 is a flow chart illustrating another method of changing a channel in the digital TV for use in the home wide web according to the preferred embodiment of the present invention. The operation of FIG. 7 is programmed in the nonvolatile memory, such as a ROM, of the memory 160 for performance by the controller 180. First, when a user turns on the digital TV (step 701), it is determined whether previous channel information is stored in the memory 160 (step 702). If the previous channel information is stored in the memory 160, the previous channel is selected (step 703). If the previous channel information is not stored in the memory 160, a channel set as a reference value when manufactured is selected (step 704). A broadcast of the channel selected in one of steps 703 and 704 is displayed until there is a request from the user for a channel change (step 705). When a user makes a request for a channel change (step 706), a channel selection page is produced by the IEEE 1394 protocol (step 707).

Subsequently, channel information contained in the channel selection page is extracted, and is stored in a separate file (step 708). When the user inputs an external operation signal to change a channel, the channel information stored in the separate file is changed according to the external operation initiated by the user. At this time, when a user tries to change a channel using direction keys (step 709), channel information is increased or decreased according to the kind of direction key operated by the user (step 710). For example, when a user manipulates a channel-up key (▴), channel information is increased by as much as “1”. When a user manipulates a channel-down key (▾), channel information is decreased by as much as “1”.

When a user does not try to change a channel using a direction key (step 709), but rather inputs a desired channel value using a digit key (step 711), a channel selection page corresponding to an input digit is produced (step 712), and then channel information is changed by a value equal to the difference between a current channel value and a channel value desired by the user as extracted by the channel information processor (step 713). That is, channel information is increased or decreased by as much as the difference between a current channel value and the channel value desired by a user. As a result, the channel is changed to channel desired by the user (step 714), so that a broadcast of the channel desired by the user is displayed on the digital TV for use in the home wide web (step 715).

As described above, the digital TV for use in the home wide web, and the method of changing a channel in the same, have an advantage in that it is very convenient to change a channel because a channel can be changed without displaying a channel change screen. In addition, since information as to various home appliances controlled by the digital TV can be stored in the cookie file when a channel selection page is produced, various services associated with the home wide web may be provided.

While the invention has been particularly shown and described with reference to preferred embodiments thereof, it will be understood by those skilled in the art that the foregoing and other changes in form and detail may be made herein without departing from the spirit and scope of the invention.

What is claimed is:

1. A digital TV for use in a home wide web, comprising:
a turner for receiving a broadcast of a current channel;
a controller for outputting a control signal to change the current channel to a user input channel;
a channel information processor for extracting user input channel information from the control signal from the controller, and for transferring the extracted user input channel information to the tuner; and
a memory including a program for operating the controller, for storing current channel information, and for changing the current channel information to the user input channel information, whereby a broadcast of the user input channel is displayed without displaying the channel selection page.

2. The digital TV of claim 1, wherein the program stores the current channel information in the form of a file.

3. The digital TV of claim 1, wherein the program stores the current channel information as a cookie file.

4. The digital TV of claim 1, further comprising at least one of a keypad and a remote controller for entry of the user input channel.

5. The digital TV of claim 1, wherein the controller is responsive to the user input channel for storing a changed channel selection page as a cookie value.

6. The digital TV of claim 5, wherein the controller is responsive to the user input channel for changing the channel of the digital TV in accordance with channel information contained in the cookie value.

7. A method of changing a channel in a digital TV for use in a home wide web, the method comprising the steps of:
producing a channel selection page to change a current channel when a user requests a change of the current channel to a user input channel;
producing and storing a first cookie for the channel selection page;
changing information of the channel selection page so as to change the current channel to the user input channel;
producing and storing a second cookie for the changed information of the channel selection page; and
changing the current channel to the user input channel by means of channel information contained in the second cookie, whereby a broadcast of the user input channel is displayed without displaying the channel selection page.

8. The method of claim 7, wherein the channel information contained in the second cookie is determined by searching a string contained in the second cookie.

9. A method of changing a channel in a digital TV for use in a home wide web, the method comprising the steps of:
producing a channel selection page to change a current channel when a user requests a change of the current channel to a user input channel;
extracting channel information from the channel selection page and storing the extracted channel information in the form of a file;
changing the channel information stored in the form of a file in response to an operation by the user; and
changing the current channel to the user input channel by means of the changed channel information, whereby a broadcast of the user input channel is displayed without displaying the channel selection page.

10. The method of claim 9, wherein, when the user manipulates a direction key to select the user input channel, a value of the current channel is changed by as much as “1”.

11. The method of claim 9, wherein, when the user manipulates a digit key to select the user input channel, the step of changing the channel information stored in the form of a file comprises:
producing a channel selection page corresponding to an input digit;
extracting channel information from the produced channel selection page and calculating a difference value between a value of the extracted channel information and a value of the channel information stored in the form of a file; and
changing the channel information stored in the form of a file by as much as the difference value.

12. A digital TV for use in a home wide web, comprising:
user input means for inputting a request by a user for change of a current channel;
means for producing a channel selection page to change the current channel when the user requests the change of the current channel to a user input channel;
means for producing and storing a first cookie for the channel selection page;
means for changing information of the channel selection page so as to change the current channel to the user input channel;
means for producing and storing a second cookie for the changed information of the channel selection page; and
means for changing the current channel to the user input channel by means of channel information contained in the second cookie, whereby a broadcast of the user input channel is displayed without displaying the channel selection page.

13. The digital TV of claim 12, wherein the channel information contained in the second cookie is determined by searching a string contained in the second cookie.

14. A digital TV for use in a home wide web, comprising:
user input means for inputting a request by a user for change of a current channel;
means for producing a channel selection page to change the current channel when the user requests the change of the current channel to a user input channel;
means for extracting channel information from the channel selection page.
means for storing the extracted channel information in the form of a file;
means for changing the channel information stored in the form of a file in response to an operation by the user; and
means for changing the current channel to the user input channel by means of the changed channel information, whereby a broadcast of the user input channel is displayed without displaying the channel selection page.

15. The method of claim 14, wherein, when the user manipulates a direction key to select the user input channel, a value of the current channel is changed by as much as “1”.

16. The method of claim 14, wherein, when the user manipulates a digit key to select the user input channel, the means for changing the channel information stored in the form of a file produces a channel selection page corresponding to an input digit, extracts channel information from the produced channel selection page, calculates a difference value between a value of the extracted channel information and a value of the channel information stored in the form of a file, and changes the channel information stored in the form of a file by as much as the difference value.
